(19) United States
(12) Patent Application Publication
(10) Pub. No.: US 2008/0093558 A1
(43) Pub. Date: Apr. 24, 2008

(54) RADIOGRAPHIC IMAGE DETECTOR AND PREPARATION METHOD OF THE SAME

(75) Inventors: Takehiko Shoji, Tokyo (JP); Masashi Kondo, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 11/874,704

(22) Filed: Oct. 18, 2007

(30) Foreign Application Priority Data
Oct. 24, 2006 (JP) JP2006-288439

(51) Int. Cl. G01T 1/20; G01T 1/24

(52) U.S. Cl. 250/361 R; 250/370.11

(57) ABSTRACT

A radiographic image detector which incorporates a scintillator panel provided with a substrate, on which a fluorescent substance layer comprised of a prismatic crystal structure is formed, and a receptor element, on which surface plural receptor pixels, to perform photoelectric conversion of light from the scintillator panel, are two-dimensionally arranged, wherein the scintillator panel is provided with a protective film to enclose and seal the substrate, and thickness h of the protective film and size L of the pixels satisfy the relationship; 0.05 L<h<1.0 L.

This application is based on Japanese Patent Application No. 2006-288439 filed on Oct. 24, 2006 in Japanese Patent Office, the content of which is hereby incorporated by reference.

### FIELD OF THE INVENTION

The present invention relates to a radiographic image detector and a preparation method of the same.

### BACKGROUND OF THE INVENTION

Heretofore, a radiographic image represented by an X-ray image has been widely utilized for diagnosis of diseases in the medical field. In recent years, a digital type radiographic image detector represented by such as a flat panel radiographic detector [FPD (Flat Panel Detector)] has been introduced to attain a radiographic image via digital information, which can be freely subjected to image processing or to enable the image information to be instantaneously transported.

In an FPD, utilized is a scintillator panel which receives radiation after having passed through an object to be radiographed and instantaneously fluorescences at a strength corresponding to the exposure dose. The emission efficiency of a scintillator panel increases as the thickness of the fluorescent substance layer increases, however, scattered light is generated in a fluorescent layer when the thickness is excessively thick, resulting in deteriorated image sharpness. To improve the diagnostic capability, it is essential to have high image sharpness.

In the case of employing a fluorescent substance via a prismatic crystal structure such as cesium iodide (CsI), generation of light scattering in the crystals is decreased due to a light-guide effect to enable increased emission efficiency to maintain image sharpness by increasing the thickness of a fluorescent layer to an optimal level. Further, emission efficiency can be improved by adding such as thallium (Tl) as an activator to cesium iodide (CsI) (for example, refer to Patent Document 1).

In Patent Document 1, a scintillator panel and a receptor element are optically coupled by laminating an organic protective film, which covers the fluorescent substance layer of a scintillator panel, with a receptor element.

[Patent Document 1] Unexamined Japanese Patent Application Publication No. 2002-116258

### SUMMARY OF THE INVENTION

### Problems to be Solved

In optical coupling, it has been proven that an image of high sharpness cannot be obtained based on the pixel size of the receptor element.

As a result of extensive studies, the applicant of this invention considered that scattering of emitted light from prismatic crystal is affecting the image sharpness and found that a radiographic image having high sharpness can be obtained by appropriately adjusting the relationship between pixel size L of a receptor element and a distance H from the top of prismatic crystal of a scintillator panel to the receptor element.

An object of this invention is to provide a radiographic image detector and a preparation method of such a radiographic image detector, which can produce radiographic images of high sharpness by appropriately adjusting the relationship between pixel size L of the receptor element and distance H from the top of prismatic crystals of the scintillator panel to the receptor element, and also to provide a radiographic image detector having a substrate protective film of thickness h, which satisfies the relationship of; 0.05 L≦h≦1.0 L.

### Means to Solve the Problems

The radiographic image detector of this invention which incorporated a scintillator panel provided on a substrate, on which a fluorescent substance layer comprising a prismatic crystal structure is formed, and a receptor element, on which surface plural receptor pixels which perform photoelectric conversion of light via the scintillator panel, are two-dimensionally arranged. Further, the detector is characterized in that the relationship of pixel size L of the photoreceptor pixels and distance H from the top of prismatic crystals to the receptor element is 0.05 L<H<1.0 L.

A preparation method of a radiographic image detector of this invention in which a radiographic image detector, can be prepared via an accumulating scintillator panel provided on a substrate, on which a fluorescent substance layer comprised of a prismatic crystal structure is formed, which is opposed to the receptor element, on which a plural number of receptor pixels are arranged. The preparation method is characterized in that a process to enclose and seal the substrate, on which a fluorescent substance layer comprising a prismatic crystal structure is formed, is provided. Further, a protective film of thickness h of 0.05 L<h<1.0 L corresponding to pixel size L of the receptor element is utilized in said process.

### Effects of the Invention

Based on this invention, distance H can be set to be from the top of the prismatic crystals of the scintillator panel to the receptor elements, which is suitable against each receptor element of varying pixel size L. Therefore, in a receptor element of varying pixel size L, emitted light from the top of the prismatic crystals of the scintillator panel is incident to the receptor elements before being diffused, whereby a radiographic image of high sharpness can be produced.

### BRIEF DESCRIPTION OF THE DRAWINGS

FIG. 1 is a constitution drawing of a radiographic image detector according to this embodiment.

FIG. 2 is an enlarged schematic drawing of the interface neighborhood of scintillator panel 12 and receptor element 13.

FIG. 3 is a constitution drawing of an evaporation apparatus utilized for preparation of scintillator panel 12.

### DESCRIPTION OF SYMBOLS

1: Radiographic image detector
12: Scintillator panel
121: Fluorescent substance layer
122: Substrate
124: First protective film
125: Second protective film
13: Receptor element

### DETAILED DESCRIPTION OF THE INVENTION

In the following, this embodiment will be explained referring to the attached drawings, however, it is only an example and this invention is not limited to this embodiment.

(Constitution of Radiographic Image Detector)

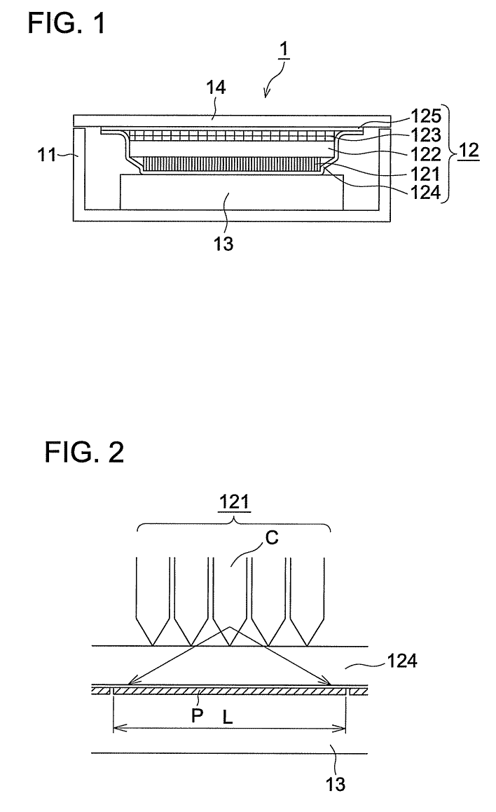

FIG. 1 shows a constitution of radiographic image detector 1 according to this embodiment. Radiographic image detector 1 is equipped with scintillator panel 12 which receives radiation having passed through a photographed object and instantaneously emits fluorescence at a strength corresponding to the exposure dose, receptor element 13 which is arranged to be pressed against scintillator panel 12 and on which surface a plural number of receptor pixels to perform photoelectric conversion are two-dimensionally arranged, and protective cover 14 which protects scintillator panel 12, in housing 11.

Scintillator panel 12 is constituted so that cushion layer 122 is arranged on the rear surface of substrate 122, on which fluorescent substance layer 121 is formed, and further these substrate 122 and cushion layer 123 are sealed with first protective film 124 and second protective film 125.

Substrate 122 is constituted of a material which allos transmission of radiation. Substrate 122 is preferably flexible so that scintillator panel 12 more closely contacts the surface of receptor element 13. For example, a flexible 125 μm polyimide film is very effective. In addition to said polyimide film, utilized may be such as cellulose ester film, polyester film, polyethylene terephthalate film, polyethylene naphthalate film, polyamide film, triacetate film, or polycarbonate film, the thickness of which is preferably 50-500 μm.

Fluorescent substance layer 121 is structured of a fluorescent layer of prismatic crystal structure providing a light guide effect resulting in high emission efficiency. For example, as a fluorescent substance material, a prismatic crystal structure can be formed on substrate 122 via vacuum evaporation of cesium iodide, which has thallium added as an activator. Instead of thallium (Tl), activators such as europium, indium, lithium, potassium, rubidium, sodium, copper, cerium, zinc, titanium, gadolinium and terbium may be utilized.

Cushion layer 123 works in conjunction with cintillator panel 12 for enhanced pressing contact against receptor element 13, under suitable pressure. For example, utilized may be a silicone or urethane type foamed material which exhibits low absorption of X-rays.

First protective film 124 and second protective film 125, which serve as an anti-moisture layer of fluorescent substance layer 121, and also for reduction for deterioration of fluorescent substance layer 121, are constituted of film having low moisture permeability. For example, utilized as such anti-moisture layer may be polyethylene terephthalate film (PET). In addition to PET, such as polyester film, polymethacrylate film, nitrocellulose film, cellulose acetate film, polypropylene film and polyethylene naphthalate film can be utilized.

Further, on the surface opposing each of first protective film 124 and second protective film 125, a fusion layer which fuses both to form a seal is provided. For example, a layer of non-stretched polypropylene may be used. Cushion layer 123 is arranged on the rear surface of substrate 122, on which fluorescent substance layer 121 has been formed, and both substrate 122 and cushion layer 123 can be sealed in a reduced pressure atmosphere by being sandwiched between first protective film 124 and second protective film 125, and by further fusing the edges, where first protective film 124 and second protective film 125 are in contact.

Receptor element 13 is constituted of plural two-dimensionally arranged receptor pixels. For example, said layer can be constituted of a photodiode plus a thin film transistor (TFT). Signal charge, which has been photo-electrically converted via a photodiode, is read out by use of a TFT. Utilized as receptor element 13 may be, such as a CMOS or a CCD.

Protective cover 14 serves the role of protecting scintillator panel 12 from such as externally generated shock as well as compressing cushion layer 123 for also pressing contact with suitable pressure between scintillator panel 12 and receptor element 13. For example, it may be constituted of a carbon plate having low absorption of X-rays. Instead an aluminum plate may be utilized as protective cover 14.

(Relationship between Pixel Size L of Receptor Element and Distance H from Top of Prismatic Crystal of Scintillator Panel to Receptor Element)

FIG. 2 is an enlarged schematic drawing of the interface neighborhood between scintillator panel 12 and receptor element 13. The top portion of prismatic crystals C, constituting fluorescent substance layer 121, has an approximately conical and sharp form. Therefore, emitted light from the top of prismatic crystal C proceeds with diffusing as shown in FIG. 2, and diffusion becomes large as the distance becomes larger. That is, when distance H from the top of the prismatic crystals of the scintillator panel to the receptor element is larger, emitted light will incident to receptor element 13 in the more diffused state.

On the other hand, pixels P are two-dimensionally arranged in receptor element 13. The pixel size (being a distance of the adjacent pixels) of pixels P is shown as “L”, and expressed by “pixel size L”.

Image sharpness will decrease when emitted light from prismatic crystals C is incident to receptor element 13 in a diffused state, and in the case of receptor element 13 having small pixel size L, the probability of diffused light being incident to the adjacent pixel will increase to cause more significant image sharpness deterioration. For this reason, in the case of utilizing receptor element 13 having small pixel size L and high resolution, it is necessary to make distance H from the top of prismatic crystals of the scintillator panel to the receptor elements shorter so that emitted light will be incident to receptor element 13 in a state of not too much diffused.

On the contrary, since the influence of diffusion of emitted light on image sharpness decrease is small in the case of utilizing receptor element 13 having large pixel size L, it is possible to make distance H from the top of prismatic crystals of the scintillator panel to the receptor to be longer to some extent.

When distance H from the top of the prismatic crystals C of scintillator panel 12 to receptor element 13 is 0.05 L<H<1.0 L, as shown in the example described later, a radiographed image having high sharpness is obtained. When the distance is not less than 1.0 L, diffusion of emitted light becomes large to cause unallowable decrease of sharpness. The smaller the distance H, the higher the sharpness, and there is no lower limit, however, protective film (in this embodiment, first protective film 124) may be broken at the contact point of the convex portion of roughness, which is present on the surface of receptor element 13 corresponding to the inter-distance of two-dimensionally arranged pixels, and the protective film, resulting in deterioration of durability of the scintillator panel. Since the number of contact points per unit area becomes smaller to increase stress acting on each contact point when inter-pixel distance L becomes larger, there is a limit of thickness, and the distance is practically difficult to be made not more than 0.05 L.

In this embodiment, the scintillator panel is prepared by sealing substrate 122 on which fluorescent substance layer 121 is formed by use of first protective film 124 and second protective film 125. And, a radiographic image detector is constituted by superposing the scintillator panel on receptor element 13. At the time of preparing a scintillator panel, by selecting protective film having a thickness h of 0.05 L<h<1.0 L as protective film 124 corresponding to pixel size L of receptor element 13, distance H from the top of prismatic crystals of a scintillator panel can be easily adjusted to 0.05 L<H<1.0 L. Thereby, a radiographic image detector in which distance H from the top of prismatic crystals of a scintillator panel is appropriately adjusted and which has high sharpness can be easily prepared.

In the above manner, according to this embodiment, for receptor element 13 having various pixel size L, each suitable distance H from the top of prismatic crystals C of scintillator panel 12 to receptor element 13 can be set. Therefore, in receptor element 13 having any pixel size L, emitted light from the top of prismatic crystals C of the scintillator panel will be incident to receptor element 13 before diffusing to an unallowable range, resulting in preparation of a radiographed image having high sharpness.

In this embodiment, distance H from the top of the prismatic crystals of the scintillator panel to the receptor element is adjusted by a thickness of protective film 124 which is arranged between the prismatic crystals of the scintillator panel and the receptor element, however, this is a preferable embodiment and the protective film is not necessarily utilized. This invention can be applied to the scintillator panel without utilizing a protective film, and for example, distance H from the top of the prismatic crystals of the scintillator panel to the receptor element may be adjusted by positioning said scintillator panel and the receptor element, respectively.

In this embodiment, cushion layer 123 is arranged in the interior of scintillator panel 12, which is sealed with first protective film 124 and second protective film 125, however, may be arranged outside of second protective film 125, and between second protective film 125 and protective cover 14.

In this embodiment, two sheets of the protective film, of first protective film 124 and second protective film 125, are utilized, however, substrate 122, on which fluorescent substance layer 121 has been formed, may be sandwiched and sealed between the one folded sheet of the protective film.

### EXAMPLES

In the following, this invention will be detailed referring to examples, however, this invention is not limited thereto.

(Preparation of Scintillator Panel)

<Formation of Fluorescent Substance Layer>

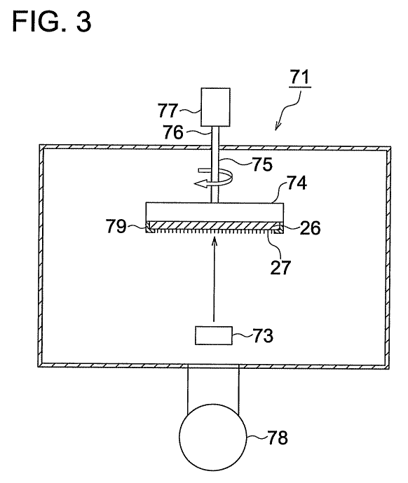

Fluorescent substance layer 27 was formed by evaporating fluorescent substance (CsI:Tl) on prepared substrate 26 by use of evaporation apparatus 71 shown in FIG. 3, whereby the scintillator panel was prepared.

A fluorescent substance starting material (CsI:Tl) was filled in resistance heating crucible 73, polyimide film substrate 26 having a thickness of 0.125 mm being arranged on support holder 79, and the distance between resistance heating crucible 73 and substrate 27 was adjusted to 400 mm. Successively, after the inside of the evaporation apparatus had been once evacuated and adjusted to a vacuum degree of 0.5 Pa by introduction of Ar gas, temperature of substrate 26 was maintained at 150° C. while rotating substrate 26 at a speed of 10 rpm. Then, resistance heating crucible 27 was heated to evaporate the fluorescent substance and evaporation was finished when the thickness of fluorescent substance layer 27 reached 500 μm.

<Preparation of Protective Film>

Polyethylene terephthalate (PET) varying the thickness as shown in Table 1 was prepared as protective film for the fluorescent substance face side. (The same film as protective film 124 for the fluorescent substance face side was utilized as protective film 125 for the substrate side of scintillator panel 12.)

A scintillator panel was sealed by use of a protective film prepared under reduced pressure in a form as shown in scintillator panel 12 of FIG. 1.

<Preparation of Receptor Element>

PaxScan 2520 (produced by Varian Medical Systems), Shad-o-Box 4K (produced by Rad-icon Imaging Corp.) and CCD receptor element 13 (privately prepared) were prepared as receptor element 13. Pixel sizes L were each 127 μm, 48 μm and 10 μm, respectively.

(Evaluation of Sharpness)

Scintillator panels 12 sealed with PET protective film having various thickness were set on receptor element 13 in a form as shown in FIG. 1.

X-rays having a tube voltage of 40 kVp were irradiated through an MTF chart made of lead, and an image data was detected by receptor element 13 which was stuck on scintillator panel 12, followed by being recorded on a hard disc. Thereafter, the record on a hard disc was analyzed by a computer to investigate an MTF (a modulation transfer function) of an X-ray image recorded on said hard disc. The investigation result [MFT value (%) at a spatial frequency of 1 cycle/mm] will be shown in following Table 1. MTF (%) in the table is an average value of 50 measurements. The higher the MTF value, the more superior the image sharpness.

TABLE 1

| Protective | | | |
|---|---|---|---|
| film | | | |
| thickness | MTF (1 cycle/mm) | | |
| (μm) | L = 127 μM | L = 48 μm | L = 20 μm |
| 3 | 75(#) | 75(#) | 75(*) |
| 5 | 75(#) | 75(*) | 75(*) |
| 12 | 75(#) | 75(*) | 75(*) |
| 20 | 75(*) | 75(*) | 73(*) |
| 25 | 74(*) | 74(*) | 59 |
| 35 | 74(*) | 73(*) | 45 |
| 50 | 74(*) | 61 | 40 |
| 75 | 73(*) | 55 | 34 |
| 100 | 73(*) | 50 | 34 |
| 125 | 72(*) | 43 | 32 |
| 150 | 62 | 41 | 31 |

In the table, those attached with “*” mark are examples of this invention. It has been proven that the samples of Examples of this invention have a high MTF value to be superior in image sharpness.

Herein, the samples in which a protective film was broken during measurement are shown by attached symbol “#”.

What is claimed is:

1. A radiographic image detector which incorporates a scintillator panel provided with a substrate, on which a fluorescent substance layer comprised of a prismatic crystal structure is formed, and a receptor element, on which surface plural receptor pixels, to perform photoelectric conversion of light from the scintillator panel, are two-dimensionally arranged,
wherein the scintillator panel is provided with a protective film to enclose and seal the substrate, and thickness h of the protective film and size L of the pixels satisfy the relationship,
0.05 L<h<1.0 L.

2. A preparation method for a radiographic image detector comprising the step of:
(i) accumulating a scintillator panel provided with a substrate, on which a fluorescent substance layer comprising a prismatic crystal structure is formed, opposed to a receptor element, on which plural receptor pixels are arranged,
wherein a process to enclose and seal the substrate, on which the fluorescent substance layer comprising the prismatic crystal structure is formed, is provided and a protective film having thickness h of 0.05 L<h<1.0 L corresponding to pixel size L of receptor pixels is utilized in the process.
